(19) United States
(12) Patent Application Publication
(10) Pub. No.: US 2009/0153319 A1
(43) Pub. Date: Jun. 18, 2009

(54) RFID Reader/Interrogator Sub-Band Selection

(75) Inventors: Mark Duran, East Patchogue, NY (US); Richard T. Knadle, JR., Dix Hills, NY (US); Russell Calvarese, Stony Brook, NY (US)

Correspondence Address: MOTOROLA, INC., 1303 EAST ALGONQUIN ROAD, IL01/3RD, SCHAUMBURG, IL, 60196, US

(73) Assignee: Symbol Technologies, Inc., Holtsville, NY (US)

(21) Appl. No.: 11/957,050

(22) Filed: Dec. 14, 2007

(51) Int. Cl. G08B 26/00

(52) U.S. Cl. 340/505

(57) ABSTRACT

Due to design constraints and installation variability, RFID interrogator antennas do not always function optimally across the entire channel on which they are intended to operate due to diminished antenna bandwidth. Techniques are described for selecting a sub-band of frequencies within the channel on which a particular RFID interrogator can be operated to enhance operating efficiency. These techniques include a VSWR measurement technique and a read/no read technique are disclosed for identifying a useful sub-band of frequencies. The operation of a reader/interrogator is then limited to an identified sub-band so that an RFID interrogator/tag system can be operated efficiently.

### BACKGROUND

The invention relates in general to the arrangement and use of radio frequency identification (RFID) tags. In particular, the invention relates to the operation of a reader/interrogator of an RFID tag system. More specifically, the invention address the problem of a reader/interrogator not being fully effective over its entire designated frequency band due to antenna design compromises and installation constraints. It provides for a selection of a sub-band of frequencies within a designated frequency band on which an RFID reader/interrogator will operate.

Radio frequency identification (RFID) tags are electronic devices that may be affixed to items whose presence is to be detected and/or monitored. RFID tags are classified based on standards defined by national and international standards bodies (e.g., EPCGlobal and ISO). Standard tag classes include Class 0, Class 1, and Class 1 Generation 2 (referred to herein as “Gen 2”). The presence of an RFID tag, and therefore the presence of the item to which the tag is affixed, may be checked and monitored wirelessly by an “RFID reader”, also known as a “reader-interrogator”, “interrogator”, or simply “reader.” Readers typically have one or more antennas for transmitting radio frequency signals to RFID tags and receiving responses from them. An RFID tag within range of a reader-transmitted signal responds with a signal including a unique identifier.

With the maturation of RFID technology, efficient communication between tags and readers has become a key enabler in supply chain management, especially in manufacturing, shipping, and retail industries, as well as in building security installations, healthcare facilities, libraries, airports, warehouses etc. Many processes, as well as the status of many items, may be readily monitored via RFID tags.

RFID systems generally operate using a frequency hop technique, thus, they transmit and receive signals on various frequencies within a communications channel in some predetermined or random sequence. In effect, they transmit bursts of frequencies in sequence at various center frequencies.

Due to design constraints and construction variability, an RFID reader/interrogator and RFID tags do not always operate optimally and efficiently over an entire communication channel on which they are intended to operate. One contributor to this problem is the antenna of the reader/interrogator. In an “ideal” world a reader/interrogator antenna, such as, for example, a dipole antenna, would be constructed so as to be “full length”, i.e. its physical length is made to be ½ wavelength at an intended operating frequency. This operating frequency may be the center of a band of frequencies constituting a communication channel.

A typical full length antenna has a pass band characteristic that permits it to operate reasonably efficiently over its entire intended communication channel. However, due to size constraints required by particular installations, the antenna of a reader/interrogator can not always be made to be full size. Design constraints may require that the antenna be shorter than ideal in order to fit within a certain size reader/interrogator or to fit the reader/interrogator within a small space allowed by a particular installation. A shorter than ideal antenna must be tuned to the correct center frequency using reactive elements.

Also, in the “ideal” world, an antenna would be installed in “free space” in such a manner that its characteristics are not affected by the dielectric properties of objects nearby. However, in the real world, particular installations require that the antenna be situated in a manner that its characteristics are indeed affected by nearby objects, such as mounting structures, etc.

Also, mechanical and electrical tolerances may accumulate during the manufacturing process which may result in an antenna frequency which is biased towards the upper or lower side of the communications channel.

Due to these and other design compromises, an antenna of a reader/interrogator may perform with a less than ideal characteristic. The antenna may not function optimally across the entire communication channel on which it is intended to operate.

For example, when a dipole antenna is constructed so that the physical dimension of its radiating element is less than ½ wavelength, it must be loaded with reactive elements in order to cause it to resonate near a center of an intended communication channel. The use of such reactive loading causes a normal antenna pass band characteristic to become more sharp, i.e. the roll off from its center frequency is more steep, and the operating bandwidth narrows more than it does for a full length antenna. Given this sharper roll off characteristic and narrower operating bandwidth, an interrogator antenna may have insufficient gain at certain frequencies to allow for reliable reception of signals and efficient response to signals. The incidence of “no read” responses from RFID tags interrogated may be too high to allow for efficient operation of the interrogator.

In addition to antenna design constraints described above, there may be other design compromises and normal construction tolerances that contribute to an RFID reader/interrogator and tag system not performing optimally over its entire intended operating channel.

What is needed, then, is an RFID reader/interrogator that can adapt its operation to compensate for an antenna that does not operate efficiently over an entire frequency band on which it is intended to operate.

### SUMMARY OF THE INVENTION

This section is for the purpose of summarizing some aspects of the inventions described more fully in other sections of this patent document. It briefly introduces some preferred embodiments. Simplifications or omissions may be made to avoid obscuring the purpose of the section. Such simplifications or omissions are not intended to limit the scope of the claimed inventions.

To a degree, the frequencies on which an interrogator/RFID tag system is to operate can be selected in advance. A particular RFID interrogator can be programmed to use the selected frequencies. Thus, if the actual center frequency and bandwidth of an interrogator antenna can become known before the interrogator is installed and put into service, it can be programmed to frequency hop within a sub-band of “good” frequencies within an intended communication channel consistent with the actual characteristics of its antenna.

The invention relates to an RFID interrogator which can be adapted to operate only within a sub-band of frequencies within an operating channel when it is not possible for it to operate efficiently over an entire channel on which they are intended to operate, such as, for example, because of antenna design constraints, installation constraints, or if another device is operating continuously within some portion of the channel and needs to be avoided. etc.

To adapt, an interrogator, can analyze interrogation results from the entire channel to identify a sub-band of frequencies within a communication channel on which it operates most efficiently and then limits its operation to only a sub-band of frequencies at which efficient operation can be carried out. The reader/interrogator is programmed such that it operates on such an identified sub-band of frequencies rather than using all frequencies within the communication channel. This allows for its more efficient use in an actual installation by allowing a higher percentage of “reads” of RFID tags responsive to its transmitted interrogation signals.

The invention described in this patent document relates in general to selecting an optimal sub-band of frequencies to which operation of an RFID interrogator should be limited within a designated communication channel. This limitation of frequencies can be accomplished by limiting the operation of a reader/interrogator to transmit interrogation signals only within the identified sub-band of frequencies. The use of a particular sub-band of frequencies allows the interrogator to operate at high efficiency.

Techniques are described herein for optimizing the operation an already constructed RFID tag interrogator by selecting a sub-band of frequencies within an intended communication channel on which it can be operated efficiently.

Normally, a reader/interrogator transmits interrogation signals. These signals are transmitted according to a frequency hopping scheme. After an RFID interrogator has been determined to operate efficiently within a sub-band of a communication channel, its operation is limited to transmitting interrogation signals only within an identified sub-band.

One technique for identifying a sub-band of frequencies for a particular RFID interrogator measures the Voltage Standing Wave Ratio (VSWR) of its antenna across its entire intended communication channel. A sub-band of optimal frequencies is identified by determining a sub-band having acceptable VSWR measurements.

A second technique for identifying a sub-band of frequencies for a particular RFID interrogator measures and tabulates responses to interrogation signals on various frequencies within the intended communication channel. A tabulation of “read” and “no read” responses indicates what frequencies are effective for interrogating the tag. A sub-band of optimal frequencies is determined based on a count of “reads” and “no read” responses.

Using either technique, the information characterizing an already manufactured RFID interrogtor can be used to select a sub-band of frequencies on which the interrogator will interrogate RFID tags in actual use. By limiting interrogation to those frequencies that are effective, the interrogator can be operated with greater efficiency than it could be if the entire spectrum of the communication channel were used. Such optimization of the interrogator results in an RFID system that operates with enhanced efficiency.

The invention can be implemented in numerous ways, including methods, systems, devices, and computer readable medium. Several embodiments of the invention are described below, but they are not the only ways to practice the invention described herein.

### BRIEF DESCRIPTION OF THE DRAWINGS/FIGURES

The accompanying drawings, which are incorporated herein and form a part of the specification, illustrate the invention and, together with the description, further serve to explain the principles of the invention and to enable a person skilled in the pertinent art to make and use the invention.

In the drawings, like reference numbers indicate identical or functionally similar elements.

Additionally, references numbers which are the same, but vary by virtue of an appended letter of the alphabet (for example, 412, 412R, 412P, 412S) or an appended letter and number (for example, 412, 412S1, 412S2) indicate elements which may be substantially the same or similar, but represent variations or modifications of the basic element. In some cases, the reference number without the appended letter or without the appended letter and number (for example, 412) may indicate a generic form of the element, while reference numbers with an appended letter or an appended letter and number (for example, 412S, 412S1, 412S2, 412P) may indicate a more particular or modified form of the element.

Additionally, the leftmost digit(s) of a reference number identifies the drawing in which the reference number first appears. For example, an element labeled 412 typically indicates that the element first appeared in FIG. 4.

FIG. 1 shows an environment where RFID readers (interrogators) communicate with an exemplary population of RFID tags.

FIG. 2 is a block diagram of receiver and transmitter portions of an RFID reader.

FIG. 3 is a block diagram of an exemplary radio frequency identification (RFID) tag.

FIG. 4 is a schematic diagram of an RFID interrogator 400 having a classic design dipole antenna 402 and a frequency response associated therewith.

FIG. 5 is a schematic diagram of a full size dipole antenna and its associated frequency response.

FIG. 6 is a schematic diagrams of a reactive loaded dipole antenna and its associated frequency response.

FIG. 7 shows a frequency response illustrating the “VSWR” technique according to the invention.

FIG. 8 is a flowchart illustrating the VSWR technique for identifying an appropriate sub-band of frequencies for operation by an RFID interrogator according to the invention.

FIG. 9 is a flowchart illustrating the “read/no-read” technique for identifying an appropriate sub-band of frequencies for operation by an RFID interrogator according to the invention.

FIG. 10 is a graphical representation indicating how the read/no read technique is used to identify a sub-band of frequencies in which the RFID interrogator will be operated.

FIG. 11 is a schematic diagram explaining how to operate an RFID tag system based on the principles of the invention.

### DETAILED DESCRIPTION

In the following description, numerous specific details are set forth in order to provide a thorough understanding of the invention. However, it will be apparent to those skilled in the art that the invention, including structures, systems, and methods, may be practiced without these specific details. The description and representation herein are the common means used by those experienced or skilled in the art to most effectively convey the substance of their work to others skilled in the art. In other instances, well-known methods, procedures, components, and circuitry have not been described in detail to avoid unnecessarily obscuring aspects of the invention.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

The terms “reader” and “interrogator” are used interchangeably. They both refer to the device used to send an interrogation signal to an RFID tag and read any signal transmitted from or backscattered from an RFID tag.

Exemplary Operating Environment

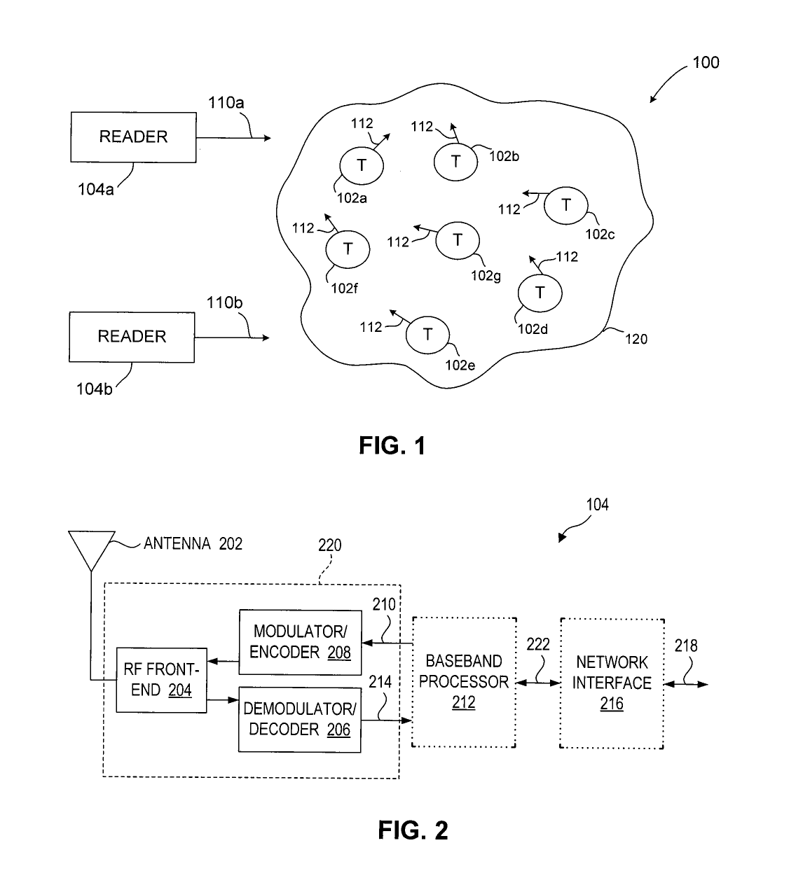

Before describing embodiments of the invention in detail, it is helpful to describe an example RFID communications environment in which the inventions may be implemented. FIG. 1 illustrates an environment 100 where RFID tag readers 104 (readers 104a and 104b shown in FIG. 1) communicate with an exemplary population 120 of RFID tags 102. As shown in FIG. 1, the population 120 of tags includes seven tags 102a-102g. A population 120 may include any number of tags 102.

Environment 100 includes any number of one or more readers 104. For example, environment 100 includes a first reader 104a and a second reader 104b. Readers 104a and/or 104b may be requested by an external application to address the population of tags 120. Alternatively, reader 104a and/or reader 104b may have internal logic that initiates communication, or may have a trigger mechanism that an operator of a reader 104 uses to initiate communication. Readers 104a and 104b may also communicate with each other in a reader network (see FIG. 2).

As shown in FIG. 1, reader 104a “reads” tags 120 by transmitting an interrogation signal 110a to the population of tags 120. Interrogation signals may have signal carrier frequencies or may comprise a plurality of signals transmitted in a frequency hopping arrangement. Readers 104a and 104b typically operate in one or more of the frequency bands allotted for this type of RF communication. For example, the Federal Communication Commission (FCC) defined frequency bands of 902-928 MHz and 2400-2483.5 MHz for certain RFID applications.

Tag population 120 may include tags 102 of various types, such as, for example, various classes of tags as enumerated above. Thus, in response to interrogation signals, the various tags 102 may transmit one or more response signals 112 to an interrogating reader 104. Some of the tags, for example, may respond by alternatively reflecting and absorbing portions of signal 104 according to a time-based pattern or frequency. This technique for alternatively absorbing and reflecting signal 104 is referred to herein as backscatter modulation. Typically, such backscatter modulation may include one or more alpha-numeric characters that uniquely identify a particular tag. Readers 104a and 104b receive and obtain data from response signals 112, such as an identification number of the responding tag 102. In the embodiments described herein, a reader may be capable of communicating with tags 102 according to various suitable communication protocols, including Class 0, Class 1, EPC Gen 2, other binary traversal protocols and slotted aloha protocols, and any other protocols mentioned elsewhere herein, and future communication protocols. Additionally, tag population 120 may include one or more tags having the packed object format described herein and/or one or more tags not using the packed object format (e.g., standard ISO tags).

FIG. 2 shows a block diagram of an example RFID reader 104. Reader 104 includes one or more antennas 202, a receiver and transmitter portion 220 (also referred to as transceiver 220), a baseband processor 212, and a network interface 216. These components of reader 104 may include software, hardware, and/or firmware, or any combination thereof, for performing their functions.

Baseband processor 212 and network interface 216 are optionally present in reader 104. Baseband processor 212 may be present in reader 104, or may be located remote from reader 104. For example, in an embodiment, network interface 216 may be present in reader 104, to communicate between transceiver portion 220 and a remote server that includes baseband processor 212. When baseband processor 212 is present in reader 104, network interface 216 may be optionally present to communicate between baseband processor 212 and a remote server. In another embodiment, network interface 216 is not present in reader 104.

In an embodiment, reader 104 includes network interface 216 to interface reader 104 with a communications network 218. As shown in FIG. 2, baseband processor 212 and network interface 216 communicate with each other via a communication link 222. Network interface 216 is used to provide an interrogation request 210 to transceiver portion 220 (optionally through baseband processor 212), which may be received from a remote server coupled to communications network 218. Baseband processor 212 optionally processes the data of interrogation request 210 prior to being sent to transceiver portion 220. Transceiver 220 transmits the interrogation request via antenna 202.

Reader 104 has at least one antenna 202 for communicating with tags 102 and/or other readers 104. Antenna(s) 202 may be any type of reader antenna known to persons skilled in the relevant art(s), including for example and without limitation, a vertical, dipole, monopole, loop, Yagi-Uda, slot, and patch antenna type.

Transceiver 220 receives a tag response via antenna 202. Transceiver 220 outputs a decoded data signal 214 generated from the tag response. Network interface 216 is used to transmit decoded data signal 214 received from transceiver portion 220 (optionally through baseband processor 212) to a remote server coupled to communications network 218. Baseband processor 212 optionally processes the data of decoded data signal 214 prior to being sent over communications network 218.

In embodiments, network interface 216 enables a wired and/or wireless connection with communications network 218. For example, network interface 216 may enable a wireless local area network (WLAN) link (including a IEEE 802.11 WLAN standard link), a BLUETOOTH link, and/or other types of wireless communication links. Communications network 218 may be a local area network (LAN), a wide area network (WAN) (e.g., the Internet), and/or a personal area network (PAN).

In embodiments, a variety of mechanisms may be used to initiate an interrogation request by reader 104. For example, an interrogation request may be initiated by a remote computer system/server that communicates with reader 104 over communications network 218. Alternatively, reader 104 may include a finger-trigger mechanism, a keyboard, a graphical user interface (GUI), and/or a voice activated mechanism with which a user of reader 104 may interact to initiate an interrogation by reader 104. An autonomous mode may be used where the reader interrogates based on a repeating timed duty cycle.

In the example of FIG. 2, transceiver portion 220 includes a RF front-end 204, a demodulator/decoder 206, and a modulator/encoder 208. These components of transceiver 220 may include software, hardware, and/or firmware, or any combination thereof, for performing their functions. Example description of these components is provided as follows.

Modulator/encoder 208 receives interrogation request 210, and is coupled to an input of RF front-end 204. Modulator/encoder 208 encodes interrogation request 210 into a signal format, such as, for example, one of pulse-interval encoding (PIE), FMO, or Miller encoding formats, modulates the encoded signal, and outputs the modulated encoded interrogation signal to RF front-end 204.

RF front-end 204 may include one or more antenna matching elements, amplifiers, filters, an echo-cancellation unit, a down-converter, and/or an up-converter. RF front-end 204 receives a modulated encoded interrogation signal from modulator/encoder 208, up-converts (if necessary) the interrogation signal, and transmits the interrogation signal to antenna 202 to be radiated. Furthermore, RF front-end 204 receives a tag response signal through antenna 202 and down-converts (if necessary) the response signal to a frequency range amenable to further signal processing.

Demodulator/decoder 206 is coupled to an output of RF front-end 204, receiving a modulated tag response signal from RF front-end 204. In an EPC Gen 2 protocol environment, for example, the received modulated tag response signal may have been modulated according to amplitude shift keying (ASK) or phase shift keying (PSK) modulation techniques. Demodulator/decoder 206 demodulates the tag response signal. For example, the tag response signal may include backscattered data formatted according to FMO or Miller encoding formats in an EPC Gen 2 embodiment. Demodulator/decoder 206 outputs decoded data signal 214.

The configuration of transceiver 220 shown in FIG. 2 is provided for purposes of illustration, and is not intended to be limiting. Transceiver 220 may be configured in numerous ways to modulate, transmit, receive, and demodulate RFID communication signals, as would be known to persons skilled in the relevant art(s).

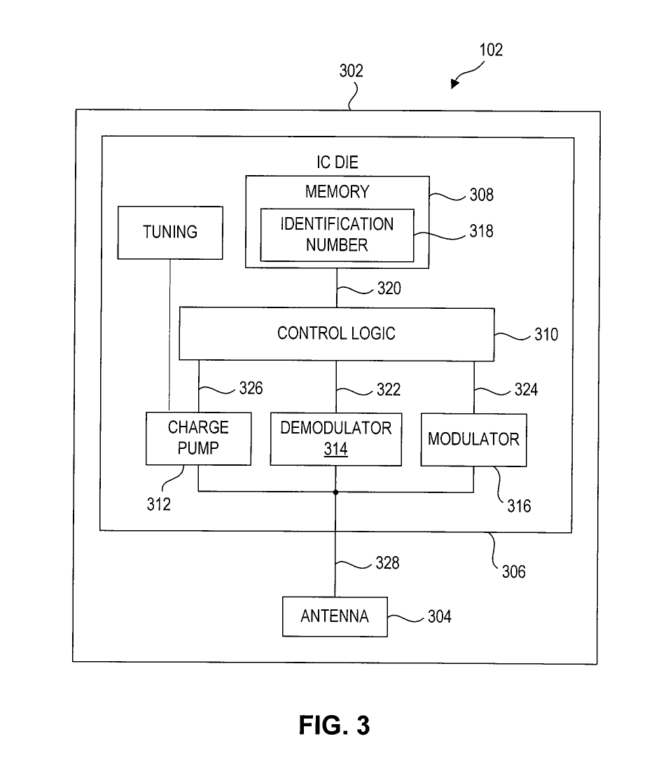

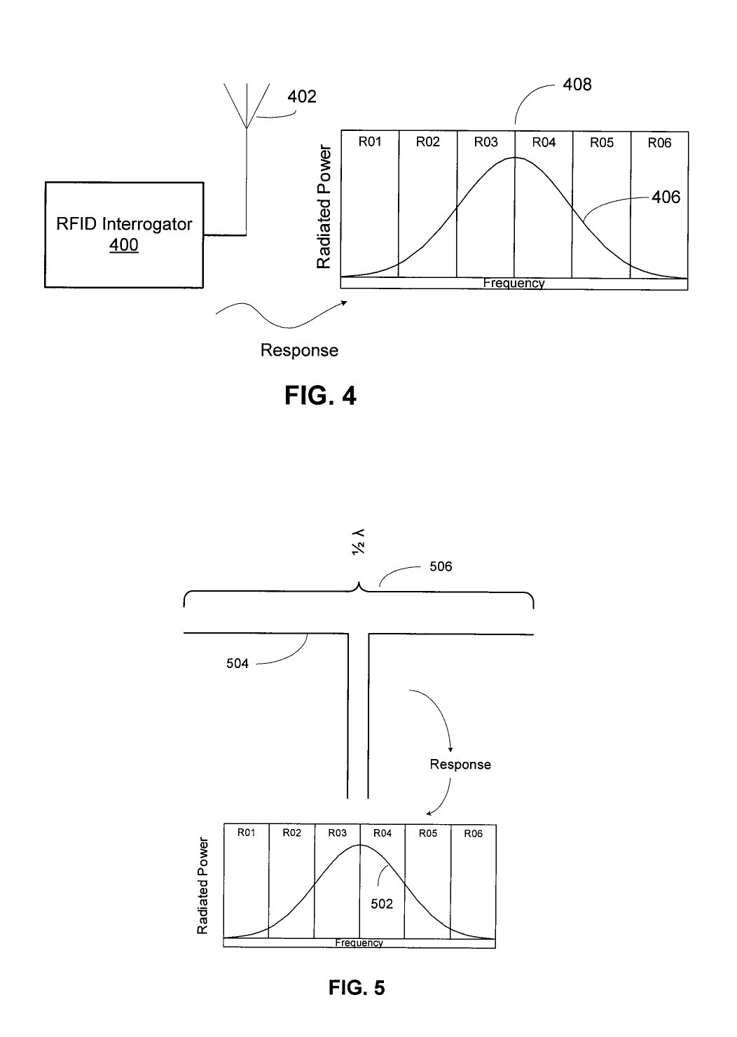

The invention described herein is applicable to any type of RFID tag, with suitable additional features, as described in further detail below in conjunction with FIG. 4 and beyond. FIG. 3 is a schematic block diagram of an example radio frequency identification (RFID) tag 102 as already known to those practiced in the art. Tag 102 includes a substrate 302, an antenna 304, and an integrated circuit (IC) 306. Antenna 304 is formed on a surface of substrate 302. Antenna 304 may include any number of one, two, or more separate antennas of any suitable antenna type, including for example dipole, loop, slot, and patch. IC 306 includes one or more integrated circuit chips/dies, and can include other electronic circuitry. IC 306 is attached to substrate 302, and is coupled to antenna 304. IC 306 may be attached to substrate 302 in a recessed and/or non-recessed location.

IC 306 controls operation of tag 102, and transmits signals to, and receives signals from RFID readers using antenna 304. In the example of FIG. 3, IC 306 includes a memory 308, a control logic 310, a charge pump 312, a demodulator 314, and a modulator 316. Inputs of charge pump 312, and demodulator 314, and an output of modulator 316 are coupled to antenna 304 by antenna signal 328.

Demodulator 314 demodulates a radio frequency communication signal (e.g., interrogation signal 110) on antenna signal 328 received from a reader by antenna 304. Control logic 310 receives demodulated data of the radio frequency communication signal from demodulator 314 on an input signal 322. Control logic 310 controls the operation of RFID tag 102, based on internal logic, the information received from demodulator 314, and the contents of memory 308. For example, control logic 310 accesses memory 308 via a bus 320 to determine whether tag 102 is to transmit a logical “1” or a logical “0” (of identification number 318) in response to a reader interrogation. Control logic 310 outputs data to be transmitted to a reader (e.g., response signal 112) onto an output signal 324. Control logic 310 may include software, firmware, and/or hardware, or any combination thereof. For example, control logic 310 may include digital circuitry, such as logic gates, and may be configured as a state machine in an embodiment.

Modulator 316 is coupled to antenna 304 by antenna signal 328, and receives output signal 324 from control logic 310. Modulator 316 modulates data of output signal 324 (e.g., one or more bits of identification number 318) onto a radio frequency signal (e.g., a carrier signal transmitted by reader 104) received via antenna 304. The modulated radio frequency signal is response signal 112 (see FIG. 1), which is received by reader 104. In one example embodiment, modulator 316 includes a switch, such as a single pole, single throw (SPST) switch. The switch is configured in such a manner as to change the return loss of antenna 304. The return loss may be changed in any of a variety of ways. For example, the RF voltage at antenna 304 when the switch is in an “on” state may be set lower than the RF voltage at antenna 304 when the switch is in an “off” state by a predetermined percentage (e.g., 30 percent). This may be accomplished by any of a variety of methods known to persons skilled in the relevant art(s).

Charge pump 312 (or other type of power generation module) is coupled to antenna 304 by antenna signal 328. Charge pump 312 receives a radio frequency communication signal (e.g., a carrier signal transmitted by reader 104) from antenna 304, and generates a direct current (DC) voltage level that is output on tag power signal 326. Tag power signal 326 powers circuits of IC die 306, including control logic 320.

Charge pump 312 rectifies a portion of the power of the radio frequency communication signal of antenna signal 328 to create a voltage power. Charge pump 312 increases the voltage level of the rectified power to a level sufficient to power circuits of IC die 306. Charge pump 312 may also include a regulator to stabilize the voltage of tag power signal 326. Charge pump 312 may be configured in any suitable way known to persons skilled in the relevant art(s). For description of an example charge pump applicable to tag 102, refer to U.S. Pat. No. 6,734,797, titled “Identification tag Utilizing Charge Pumps for Voltage Supply Generation and Data Recovery,” which is incorporated by reference herein in its entirety. Alternative circuits for generating power in a tag, as would be known to persons skilled in the relevant art(s), may be present. Further description of charge pump 312 is provided below.

It will be recognized by persons skilled in the relevant art(s) that tag 102 may include any number of modulators, demodulators, charge pumps, and antennas. Tag 102 may additionally include further elements, including an impedance matching network and/or other circuitry. Furthermore, although tag 102 is shown in FIG. 3 as a passive tag, tag 102 may alternatively be an active tag (e.g., powered by a battery, not shown).

Memory 308 is typically a non-volatile memory, but can alternatively be a volatile memory, such as a DRAM. Memory 308 stores data, including an identification number 318. In a Gen-2 tag, tag memory 308 may be logically separated into four memory banks.

Overview of Sub-Band Identification for RFID Interrogator

The following sections of this specification, along with FIGS. 4 through 11, describe exemplary embodiments that incorporate the features of the inventions. The embodiment(s) described, and references in the specification to “exemplary embodiment”, “one embodiment”, “an embodiment”, “an example embodiment”, etc., indicate that the embodiment(s) described may include a particular procedure, operation, step, feature, structure, or characteristic, but every embodiment may not necessarily include the particular procedure, operation, step, feature, structure, or characteristic. Moreover, such phrases are not necessarily referring to the same embodiment. Further, when a particular procedure, operation, step, feature, structure, or characteristic is described in connection with an embodiment, it is understood that it is within the knowledge of one skilled in the art to effect such procedure, operation, step, feature, structure, or characteristic in connection with other embodiments whether or not explicitly described.

While specific methods and configurations are described, it should be understood that this is done for illustration purposes only. A person skilled in the art will recognize that other configurations and procedures may be used without departing from the spirit and scope of the invention.

In particular, RFID reader and system embodiments are described wherein within a particular frequency band channel of operation, a sub-band of frequencies is selected on which the RFID reader can optimally operate.

FIG. 4 schematically shows an RFID interrogator 400 having an integrated dipole antenna 402. Dipole antenna 402 is a classic dipole design having a physical length equal to one-half wavelength at the center frequency of a channel defined by a band of frequencies in which RFID interrogator 400 is intended to operate. The graph in FIG. 4 demonstrates characteristics of antenna 402 in a plot 406 indicating amplitude of radiated power of signals emitted by RFID interrogator 400 via antenna 402. As shown in plot 406, there is a frequency 408 at which antenna 402 is perfectly resonant. For frequencies greater than the resonant frequency 408 and for frequencies less than the resonant frequency 408, the amplitude of radiated power is less than it is at the resonant frequency 408. For purposes of discussion the full channel is divided into parts designated R01, R02, R03, R04, R05, and R06.

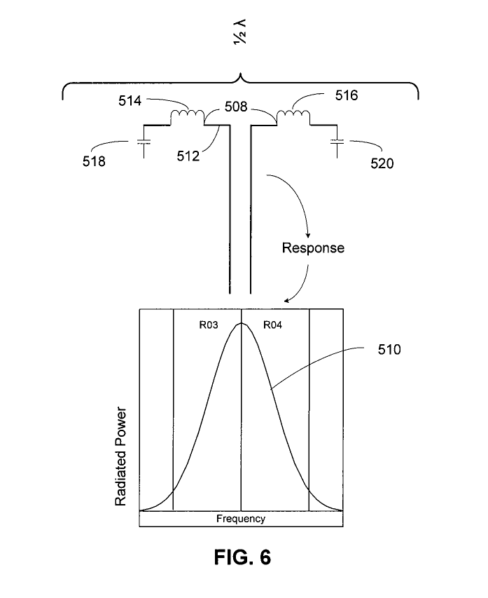

FIGS. 5 and 6 demonstrate how the characteristic of an antenna changes when the antenna is shortened from its ideal ½ wavelength physical length. FIG. 5 schematically shows an antenna characteristic 502 corresponding to a dipole antenna 504 that has a physical length 506 equal to ½ wavelength. In order to integrate an antenna into a smaller space than can accommodate a ½ wavelength antenna, the antenna can be made to have a physical length 508 that is less than ½ wavelength at the center of its intended operating channel, as shown in FIG. 6. In order to maintain a resonant frequency 510 at the center of its channel, a short antenna 512 must be loaded with inductive elements such as inductors 514 and 516 and capacitive elements such as capacitors 518 and 520. However, as shown in plot 510, the response curve of antenna 512 becomes much narrower than the response curve 502 of a full size antenna such as antenna 504. Because of this narrower response curve, and because of other tolerances in building an RFID reader antenna, an RFID reader may not operate as desired over a full range of frequencies for a communication channel on which it is intended to operate.

### VSWR Technique for Sub-Band Identification

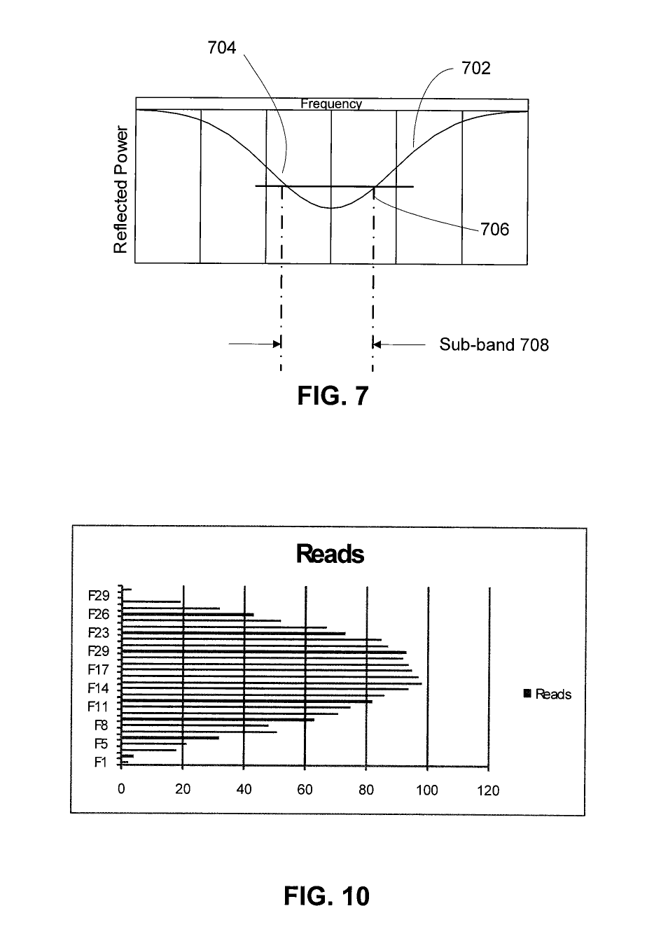

FIG. 7 is a frequency response illustrating the “reflected power” concept of the invention. One solution to the problem of having a less than ideal antenna response is to program an RFID interrogator to operate only on frequencies that are within a portion of an antenna response curve that permits a sufficient signal to be transmitted and received. RFID interrogators generally operate in a frequency hopping mode. Rather than use all frequencies available within a particular communication channel, the interrogator can be operated on only those frequencies that allow for good transmission of interrogation signals and reception of backscatter signals based on an actual response curve of an actual antenna integrated into the RFID interrogator.

There are various ways to identify a sub-band of frequencies of a communication channel on which a particular interrogator should be operated in order to properly receive and transmit signals. One such technique is the measure the VSWR of the interrogator antenna over its entire intended communication channel frequency range and to then limit frequencies of actual use to those falling within a “sweet spot” of low VSWR. In FIG. 7, a full response curve 702 is shown with a sweet spot range from a first frequency 704 to a second frequency 706. The range of frequencies from frequency 704 to frequency 706 defines a sub-band 708 constituting a sweet spot for an antenna installed in a particular RFID interrogator.

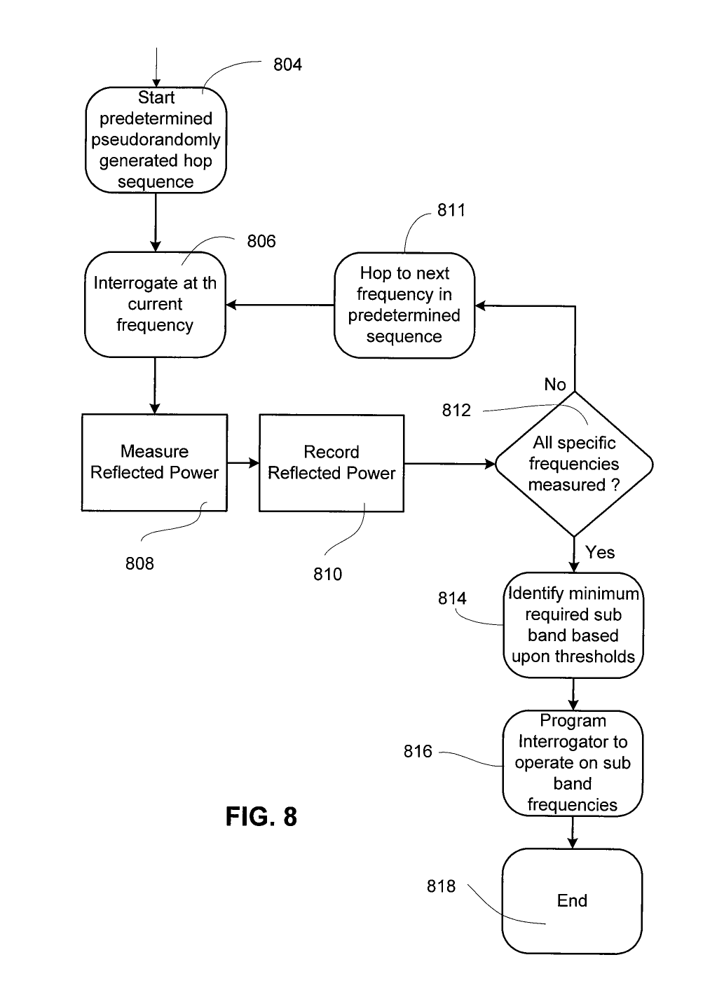

FIG. 8 is a flowchart showing the process of identifying an appropriate sub-band of frequencies for operation by an RFID interrogator being matched to an integrated antenna using VSWR techniques according to the invention. Beginning at step 804, a predetermined pseudo random frequency hopping sequence is begun. At step 806, the first of the identified frequencies is used to test the antenna. A standard RFID interrogation is performed while the antenna and it's reflected power is measured at step 808. The level of reflected power is recorded at step 810. At step 812, it is determined whether there are additional frequencies at which measurements are to take place. If there are additional frequencies, Then in step 811 the next frequency in the hop sequence is selected and control returns to step 806. The process at step 806, 808, 810 and 811 continues until all frequencies within the gross frequency band have been tested and reflected power recorded. Once all frequencies have been tested, and there are no other frequencies to test, control passes to step 814 whereat a sub-band of frequencies is identified. Once the sub-band of frequencies has been identified, the RFID interrogator can be programmed at 816 to only used the identified frequencies for actual operation. Control ends at step 818. Once a sub-band of frequencies has been identified, an interrogator can be programmed to send interrogation signals only on those frequencies within the identified sub-band.

“Read/No Read” Technique for Sub-Band Identification

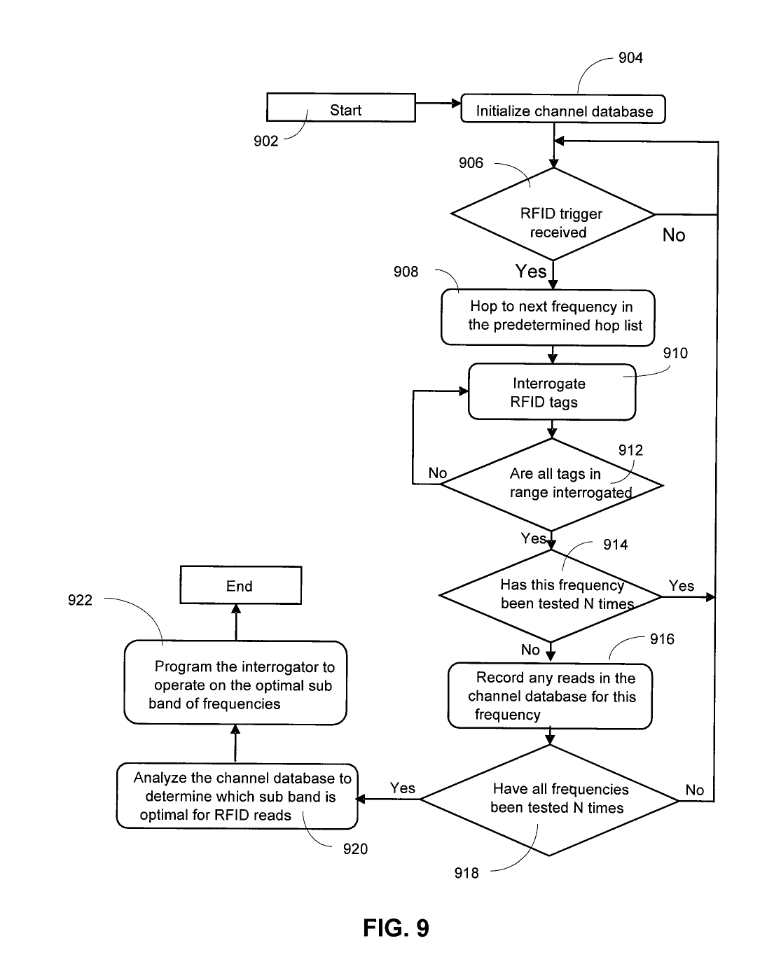

FIG. 9 is a flowchart showing an alternative process of identifying an appropriate sub-band of frequencies for operation by an RFID tag being matched to an integrated antenna using a “read or no read” technique rather than measuring antenna VSWR. Once an RFID interrogator has been built the installed antenna's response is tested by transmitting actual interrogating signals throughout the entire channel on which it is intended to operate. Actual “reads” are measured to determine the response of test RFID tags. This technique is advantageous in that no VSWR measurements need to be made. The process is begun at step 902. At step 904 a database of all possible channel numbers is initialized to zero. At step 906 the system awaits a trigger from any controlling process or user. When a trigger is received, the system advances to step 908 where the system selects the next frequency to operate on from a predetermined list of pseudorandomly generated channel numbers. The system then advances to step 910 where the actual RFID reads occur. The system will repeatedly loop through steps 910 and 912 until all RFID tags within range are interrogated. Once it is determined that no more unread tags remain in the interrogation space, the system advances to step 914 where a test is made to determine if the currently selected channel has been tested N times. N is an integer which represents the number of times each frequency must be tested before a channel efficiency comparison can be made accurately. The higher the number N, the greater the integration factor of the test, and the more that factors that are external to the system are averaged out of the measurement. This needs to be done to remove such factors as RF multipath, interference from other interrogators or other RF devices, tag distribution variances, and environmental variables are also minimize in the measurement. If it is determined that N has been satisfied for the current channel, the system will return to step 906 to repeat the above sequence, otherwise the system advances to step 916. In step 916 any tag reads from the latest round of interrogations are aggregated with any reads from prior rounds of interrogations that have been stored in the current channel database. The results are used to overwrite the prior values in the current channel memory location. The current N value for the current channel is also incremented in the database. The system then advances to step 918. In step 918, a test is done to determine if all N values for all channals have reached their terminal values. If not, the system returns to step 906 to await a new trigger command, otherwise the system continues to step 920. In step 920 a histogram is made from the database of channel reads to determine the optimal sub band for the interrogator to operate on. The system then continues to step 922 where the interrogator is programmed to operate only on the optimal sub band determined in step 920. The process then terminates and returns to normal RFID operation using the new optimal sub band of channels.

FIG. 10 is a graphical representation explaining step 920 in FIG. 9. The plot indicates how the cumulated read/no read results are used to help identify a sub-band of frequencies in which the RFID tag will be operated. As shown in FIG. 10, frequencies were selected for tests within a gross band of frequencies. A threshold can be established to help make a decision as to the appropriate number of reads for a given number of attempts are acceptable.

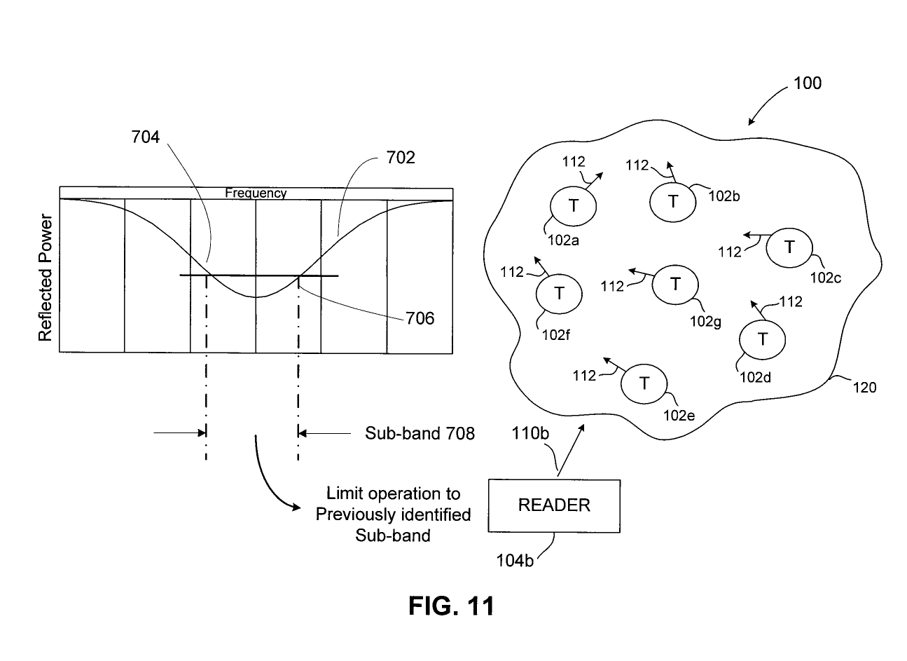

FIG. 11 is a schematic diagram explaining how to operate an RFID tag system based on the principles of the invention. As in the system shown in FIG. 1, an interrogator (reader) 104a transmits interrogation signals 110a to RFID tags 102. Reader 104a is not effective over its entire designated frequency band of operation because of design constraints for its antenna and or installation constraints. After identifying a sub-band of frequencies 708 on which the interrogator operates effectively, interrogation signals 110a are limited to those frequencies within the identified sub-band.

Persons skilled in the relevant arts will recognize that the elements, methods, techniques, and principles of the inventions may be applied, with suitable modifications, to other kinds of radio frequency reporting systems which may employ mechanically modifiable elements.

### CONCLUSION

The above examples of a system and method for operating an RFID interrogator are exemplary only. Persons skilled in the relevant arts will recognize that a variety of alternatives may exist in terms of materials, relations of structural and operational elements, and methods of employing or applying the same. Such variations fall within the scope and spirit of the invention which is not limited by the particular examples described above.

While various embodiments of the invention have been described above, it should be understood that they have been presented by way of example only, and not limitation. It will be apparent to persons skilled in the relevant art that various changes in form and detail can be made therein without departing from the spirit and scope of the invention. Thus, the breadth and scope of the invention should not be limited by any of the above-described exemplary embodiments, but should be defined only in accordance with the following claims and their equivalents.

What is claimed is:

1. A method for operating an RFID interrogator comprising:
identifying a gross band of frequencies over which the interrogator is capable of operating;
measuring characteristics of an antenna associated with the interrogator; and
operating the interrogator within a sub-band of frequencies based upon characteristics of the antenna as measured.

2. A method according to claim 1 wherein the operating comprises transmitting interrogation signals from the interrogator only within the sub-band of frequencies.

3. A method according to claim 1 wherein the measuring comprises:
identifying specific frequencies within the gross frequency band;
exciting the antenna by transmitting signals at selected frequencies within the identified gross frequency band; and
measuring power reflected from the antenna at the selected frequencies.

4. A method according to claim 1 wherein the measuring comprises:
identifying specific frequencies within the gross frequency band;
exciting the antenna by transmitting signals at selected frequencies within the identified gross frequency band; and
measuring power radiated by the antenna at the selected frequencies.

5. A method according to claim 3 further comprising:
identifying a threshold of reflected power; and
identifying a sub-band of frequencies based on a frequency response of the antenna with respect to that threshold.

6. A method according to claim 1 wherein the antenna is a dipole antenna.

7. A method according to claim 1 wherein the antenna is a spiral pattern antenna.

8. A method for operating an RFID interrogator comprising:
identifying a gross band of frequencies over which the RFID interrogator is capable of operating;
measuring responses of test RFID tags at discrete frequencies within the gross band of frequencies;
identifying a sub-band of frequencies within the gross band of frequencies in which the test RFID tags responded according to predetermined criteria; and
operating the RFID interrogator only within the sub-band of frequencies.

9. A method according to claim 8 wherein the operating comprises transmitting interrogation signals only within the sub-band of frequencies.

10. A method according to claim 8 wherein the measuring comprises:
identifying specific frequencies within the gross frequency band;
transmitting from the interrogator signals to test RFID tags at each specific frequency; and
measuring whether the test RFID tags respond to each transmitted signal.

11. A method according to claim 10 further comprising:
identifying a threshold of read/no read response per attempt; and
identifying a sub-band of frequencies based whether a number of reads exceeds the threshold.

12. A method according to claim 8 wherein the antenna is a dipole antenna.

13. A method according to claim 8 wherein the antenna is a spiral pattern antenna.

14. An RFID tag system, comprising:
an RFID tag; and
an RFID interrogator, the RFID interrogator comprising:
an antenna constructed and arranged to transmit interrogation signals to the RFID tag and to receive backscatter signals there from;
control logic constructed and arranged to control the interrogator in a manner to cause it to send interrogation signals only on particular frequencies on which the interrogator has been previously determined to operate according to predetermined criteria.

15. An RFID tag system according to claim 14 wherein the control logic is constructed and arranged to cause the interrogator to transmit interrogation signals only on a sub-band of frequencies within its normal range of operating frequencies based on previously measured characteristics of the antenna.
